(19) United States
(12) Patent Application Publication
(10) Pub. No.: US 2004/0248724 A1
(43) Pub. Date: Dec. 9, 2004

(54) Silicate-based sintering aid and method

(76) Inventors: Sridhar Venigalla, Macungie, PA (US); David V. Miller, Pittsburgh, PA (US); Jeffrey A. Kerchner, Fleetwood, PA (US); Kathleen A. Thrush, Dresher, PA (US)

Correspondence Address: Martha Ann Finnegan, Esq., Cabot Corporation, 157 Concord Road, Billerica, MA, 01821, US

(21) Appl. No.: 10/729,801

(22) Filed: Dec. 4, 2003

Related U.S. Application Data
(63) Continuation of application No. 09/640,498, filed on Aug. 16, 2000, now abandoned.
(60) Provisional application No. 60/150,270, filed on Aug. 23, 1999.
(60) Provisional application No. 60/177,527, filed on Jan. 21, 2000.

(51) Int. Cl. C04B 35/468; C03C 3/078

(52) U.S. Cl. 501/137; 501/72

(57) ABSTRACT

The present invention is directed to a silicate-based sintering aid and a method for producing the sintering aid. The sintering aid, or frit, may be added to dielectric compositions, including barium titanate-based compositions, to lower the sintering temperature. The sintering aid may be a single or multi-component silicate produced via a precipitation reaction by mixing solutions including silicon species and alkaline earth metal species. The sintering aid can be produced as nanometer-sized particles, or as coatings on the surfaces of pre-formed dielectric particles. Dielectric compositions that include the sintering aid may be used to form dielectric layers in MLCCs and, in particular, ultra-thin dielectric layers.

### RELATED APPLICATIONS

This application claims priority to U.S. provisional application Ser. No. 60/150,270, filed Aug. 23, 1999, entitled “Aqueous-Based Ni-Electrode Compatible Dielectrics for Advanced Multilayer Ceramic Capacitors,” and to U.S. provisional application Ser. No. 60/177,527, filed Jan. 21, 2000, entitled “Aqueous-Based Ni-Electrode Compatible Dielectrics for Advanced Multilayer Ceramic Capacitors,” the disclosures both of which are incorporated herein by reference.

### FIELD OF THE INVENTION

The present invention is directed to dielectric materials and, more particularly, to a silicate-based sintering aid used in dielectric compositions and a process to form the sintering aid.

### BACKGROUND OF THE INVENTION

Dielectric compositions, including barium titanate-based compositions, are used in many electronic applications. For example, such compositions may be used to form the dielectric layer in multilayer ceramic capacitors (MLCCs). MLCCs comprise alternating layers of dielectric and electrode materials. Certain types of MLCCs utilize nickel-based internal electrodes. Nickel-based electrodes may provide advantages over precious metal (e.g., Pd, Ag—Pd) electrodes such as cost savings, enhanced solderability and thermal shock resistance, as well as improved overall reliability of the MLCC.

The dielectric layer of MLCCs are usually prepared from a high solids dispersion, which typically includes a dielectric powder and a polymeric binder in solvent. The dispersion, or slip, may be cast to provide a “green” layer of ceramic dielectric material. A patterned electrode material is then formed on the green layer to form a structure that is stacked to provide a laminate of alternating layers of green ceramic dielectric and electrode. The stacks are diced into MLCCs-sized cubes which are heated to burn off organic materials, such as binder and dispersant, and are then fired to sinter the particles of barium titanate-based material to form a capacitor structure with laminated, dense ceramic dielectric and electrode layers. During sintering, increased ceramic dielectric density is achieved as a result of the fusion and consolidation of the particles to form grains.

Sintering aids are often added as a minor constituent (e.g., less than 5 weight percent) to dielectric compositions to lower the sintering temperature. Lower sintering temperatures can reduce processing costs (e.g., by using less energy) and may provide greater control over the process. Silicate-based glass forming additives, also called frits, are often used as sintering aids due to their low-melting temperature and chemical/material compatibility. In particular, most nickel-electrode compatible dielectric formulations include a frit to reduce sintering temperature. Examples of frits include pure, colloidal SiO₂ and compound silicates.

Conventionally, silicate sintering aids are manufactured using melt techniques, where individual oxides are mixed together and heated to a molten state, quenched and solidified into a single glass phase. The solid glass is subsequently crushed and milled to reduce the particle size. The resulting powder typically has a particle size of between about 1 and 10 microns (depending on milling time), a non-spherical and irregular particle morphology, and a multi-modal particle size distribution. Furthermore, the milling process is time consuming (e.g., several hours) and may introduce contamination from the milling media.

Recent strides in microelectronic and communication technologies have propelled the miniaturization of MLCCs, while the performance requirements have tremendously increased: higher capacitance in smaller case sizes (high volumetric efficiency), higher mechanical strength and reliability. In order to meet these advanced performance features, there is a need for the manufacture of uniform, ultra-thin dielectric layers (e.g., less than 3 microns fired thickness).

Accordingly, a need exists for a sintering aid that may be added to dielectric compositions that are used to fabricate thin dielectric layers.

### SUMMARY OF THE INVENTION

The present invention is directed to a silicate-based sintering aid, a method for producing the sintering aid, and a dielectric composition including the same and capacitor devices made from such a composition.

In one aspect, the invention provides a method of preparing a sintering aid. The method includes mixing a first solution comprising a silicon ionic species with a second solution comprising an alkaline earth metal ionic species. The method further includes reacting the silicon ionic species with the alkaline earth metal ionic species to form a silicate-based sintering aid.

In another aspect, the invention provides a sintering aid. The sintering aid includes alkaline earth metal silicate-based particles having an average particle size of less than about 500 nm and a substantially spherical shape.

In another aspect, the invention provides a barium titanate-based particulate composition. The composition includes barium titanate-based particles coated with an alkaline earth metal silicate-based sintering aid.

In another aspect, the invention provides a barium titanate-based composition. The composition includes barium titanate-based particles, and alkaline earth metal silicate-based particles having an average particle size of less than about 500 nm.

In another aspect, the invention provides a multilayer ceramic capacitor. The multilayer ceramic capacitor includes a dielectric layer comprising barium titanate-based particles coated with an alkaline earth metal silicate-based sintering aid.

In another aspect, the invention provides a multilayer ceramic capacitor. The multilayer ceramic capacitor includes a dielectric layer comprising barium titanate-based particles and alkaline earth metal silicate-based particles having an average particle size of less than about 500 nm.

Other advantages, novel features, and aspects of the invention will become apparent from the following detailed description of the invention when considered in conjunction with the accompanying figures, and from the claims.

### BRIEF DESCRIPTION OF THE DRAWINGS

The foregoing, and other objects and advantages, will be more fully appreciated from the following drawings, in which:

FIGS. 1A and 1B respectively are transmission electron microscope (TEM) micrographs of the barium-calcium silicate particles produced in Example 1 and commercially available barium-calcium silicate particles.

FIG. 2 is a TEM micrograph of the barium-calcium silicate particles produced in Example 1 mixed with barium titanate-based particles to form a dielectric composition.

FIG. 3 shows a graph comparing the particle size of dielectric compositions including the barium-calcium silicate particles produced in Example 1 (Line A) to dielectric compositions including the commercially available barium-calcium silicate particles (Line B).

FIG. 4 is a graph of the dilatometric thermal shrinkage profiles illustrating the reduction of the sintering temperature of a dielectric composition including 0 mol %, 1 mol %, 2 mol %, and 3 mol % concentrations, respectively, of the barium-calcium silicate particles produced in Example 1.

FIG. 5 is a graph comparing the dilatometric thermal shrinkage profiles of a dielectric composition including the barium-calcium silicate particles produced in Example 1 (Line A) and a dielectric composition including commercially available barium-calcium silicate particles (Line B).

FIG. 6 is a graph comparing the dilatometric thermal shrinkage profiles of a dielectric composition including barium silicate particles produced in Example 2 and a dielectric composition including conventional silicon dioxide particles.

FIG. 7 is a TEM micrograph of the barium titanate particles including a barium silicate coating produced in Example 3.

FIG. 8 is a graph comparing the dilatometric thermal shrinkage profiles of the coated barium titanate particles produced in Example 3 and a dielectric composition including barium silicate particles produced according to a method of the present invention.

### DETAILED DESCRIPTION OF THE INVENTION

The present invention is directed to a silicate-based sintering aid and a method for producing the sintering aid. The sintering aid may be a single component silicate, such as barium silicate (BaSiO₃), or a multi-component silicate, such as barium-calcium silicate (BaₓCa₁₋ₓSiO₃). In some embodiments, the sintering aid may be produced as nano-sized particles which can be mixed with barium titanate-based particles to form a dielectric composition. In other embodiments, the sintering aid may be produced as a coating on the surfaces of barium titanate-based particles to form a dielectric composition. The dielectric compositions that include the sintering aid, either as particles or as coatings, may be sintered at relatively low temperatures, for example, to form dielectric layers in MLCCs and, particularly, MLCCs having ultra-thin layers.

The silicate-based sintering aid is produced using a precipitation reaction. The method generally involves mixing together appropriate reactive species under the proper conditions to cause the precipitation reaction to occur. In some embodiments, a solution that includes a silicon ionic species is mixed with a solution that includes an alkaline earth metal ionic species to form a reaction mixture. Under appropriate conditions, the silicon ionic species reacts with the alkaline earth metal ionic species to produce the silicate-based sintering aid in the desired form.

As used herein, a “silicon ionic species” is any ion that includes silicon and is capable of reacting with an alkaline earth metal ion to form a silicate compound. Examples of suitable silicon ionic species are silicate ions (SiO₃²⁻) and silicon ions Si (Si⁴⁺). In some embodiments, the silicon ionic species are provided in aqueous solutions. Certain preferred aqueous solutions include aqueous solutions of silicate compounds that dissociate in water, such as sodium silicate (Na₂SiO₃), or acids such as silicic acid. In certain embodiments, silicic acid may be produced using a conventional ion exchange column by introducing sodium silicate into the column and exchanging sodium with hydrogen to form silicic acid which is retrieved. Other suitable solutions for containing the silicon ionic species include solutions of silicon tetrachloride (SiCl₄), silicon oxychloride (SiOCl₂), ethyl silicate Si(OC₂H₅)₄, and silicon alkoxides, such as tetramethoxysilane and tetraethoxysilane.

As used herein, an “alkaline earth metal ionic species” is any ion that includes an alkaline earth metal and is capable of reacting with a silicon ion to form a silicate compound. The particular alkaline earth metal ionic species may be selected to produce a sintering aid having the desired silicate-based composition, as described further below. The alkaline earth ionic species, for example, may be derived from solutions of suitable hydroxides, hydrates including octahydrates, or oxides of the alkaline earth metals including barium, calcium, strontium, or magnesium. In some cases, preferred alkaline earth metal ionic species are provided from solutions of barium hydroxide, barium hydroxide octahydrate, calcium oxide, or calcium hydroxide. When multi-component silicates (i.e., silicates that include more than one alkaline earth metal), are being produced, more than one ionic alkaline earth metal ionic species is added to the reaction mixture. For example, in some embodiments when barium-calcium silicate is produced, barium hydroxide and calcium hydroxide may both be added to the reaction mixture. In multi-component silicate embodiments, the respective reactive species may be added to the reaction mixture in relative proportions that yields a silicate having the desired stoichiometric ratio.

Silicon ionic species and alkaline earth metal ionic species are sometimes referred to herein as “reactive species.” In some embodiments, respective solutions including the silicon ionic species and the alkaline earth metal ionic species may be mixed to form the reaction mixture. In other embodiments, silicon ionic species and the alkaline earth metal ionic species may be dissolved in the same solution to form the reaction mixture.

The reaction mixture is generally contained in a reaction chamber. In some embodiments, the chamber may be open to the atmosphere. In other embodiments, the chamber may be at atmospheric pressure, but enclosed so as to prevent the species in the mixture from reacting with atmospheric gases (e.g., the reaction between barium ions and carbon dioxide). In some embodiments, to further insure that no reaction occurs between the reaction species and the atmosphere, the chamber may be purged with a non-reactive gas such as argon or nitrogen.

In some cases, the mixture of the aqueous solutions including the reactive species is mixed and/or heated to promote the precipitation reaction. Mixing may be accomplished using any standard technique known in the art. When heating is employed, the reaction mixture is heated to a temperature at which the reaction proceeds at an efficient rate. In some cases, the reaction mixture may be heated to a temperature between about 60° C. and 100° C. and, in some cases, to a temperature between about 80° C. and 90° C. The specific reaction temperature depends upon the particular reactive species. In some cases, heating may not be required. In particular, when the silicate-based sintering aid is produced as a coating on dielectric particles, heating may not be required as described further below.

The reaction typically proceeds until completion, when one of the reactive species is completely or nearly exhausted. The reaction time depends upon a number of factors, including the reaction conditions and reactive species, and is typically on the order of about a few hours.

In some embodiments, the precipitation reaction is most efficient at basic conditions. Because many aqueous solutions including alkaline earth metal ionic species are bases (e.g., BaOH), a separate pH adjusting compound may not be required to increase the pH of the mixture. However, in some cases, a pH adjusting compound that does not interfere with the reaction may be added to maintain a desired pH. In some embodiments, the solution containing the alkaline earth metal ionic species or the pH adjusting compound is added in sufficient amounts to maintain the pH above a certain level, for example, above about 12 or above about 13.

The same general precipitation reaction may be used to produce the silicate-based sintering aid as particles or as coatings on pre-formed dielectric particles, though certain reaction conditions may differ.

To produce coatings, the reaction mixture (or the individual reactive species) is mixed with a slurry generally containing between about 5 and 20 weight percent of barium titanate-based particles. During the reaction, the silicate compounds typically precipitate as coatings rather than as particles, due to the lower energy required to precipitate onto a pre-existing surface (i.e., barium titanate-based particles) than to nucleate a separate particle. However, in some cases, silicate compounds may precipitate both as coatings and as particles. When coating barium titanate-based particles, the reaction mixture may need to be mixed more vigorously then in processes for producing silicate-based particles to maintain the particles as a slurry. The reaction mixture may not need to be heated when coating the silicate-based sintering aids onto the barium titanate-based particles because of the lower energy associated with precipitating onto an existing particle surface. After the coating step, the particles may be filtered and washed, for example using de-ionized water, to remove residual reactive species. The washed coated particles may be dried, for example by heating in a vacuum furnace, and later re-dispersed for further processing to form dielectric layers. Alternatively, the washed coated particles may be maintained in a slurry until further processing.

When silicate-based particles are desired, they may be precipitated directly from the reaction mixture. The resulting product which includes the silicate-based particles dispersed in an aqueous medium is filtered and washed, for example using de-ionized water, to remove residual reactive species. The washed particles may be dried, for example, by heating in a vacuum furnace. In other cases, the washed particles may be maintained in a slurry. The silicate-based particles may be mixed with barium titanate-based particles to form a dielectric composition. In some embodiments, the silicate-based particles may be added to a slurry of barium titanate-based particles. When added to the slurry of barium titanate-based particles, the silicate-based particles may be dried or may be slurried as well. In other embodiments, dried silicate-based particles may be added to dried barium titanate-based particles. In any case, is generally preferable to sufficiently mix the silicate based-particles with the dielectric-based particles to produce a uniform dielectric composition.

The silicate-based sintering aid (particles and coatings) may be any silicate-based composition having the general formula MSiO₃, wherein M represents one or more alkaline earth metals. The specific silicate composition depends upon the requirements of the particular application. Suitable alkaline earth metals include barium, calcium, magnesium, and strontium. In embodiments when M represents one alkaline earth metal, the composition is a single component silicate. Barium silicate (BaSiO₃) is a preferred single component silicate in some cases. In embodiments when M represents more than one alkaline earth metal, the composition is a multi-component silicate. Barium-calcium silicate (BaₓCa₁₋ₓSiO₃) is a preferred a multi-component silicate in some embodiments. When barium-calcium silicate is produced, x may be between about 0.4 and about 0.6 in certain preferred cases.

In some cases, the presence of the alkaline earth metals in the sintering aid is desirable because it increases the A/B ratio of the dielectric composition to greater than 1.0. The A/B ratio is the ratio of divalent metals (e.g., alkaline earth metals such as Ba, Ca, etc.) to tetravalent metals (Ti, Zr, Sn, etc.) in the overall dielectric composition. A high A/B ratio may be desired in dielectric compositions to increase compatibility with base metal electrodes, as described further below.

When provided in particulate form, the silicate-based sintering aid generally has an average particle size of less than about 500 nm. As used herein, the term average particle size refers to the average particle size of primary particles in a composition. In many cases, silicate-based particles have even smaller particle sizes. For example, in some cases, the silicate-based particles have an average particle size of less than about 250 nm; in some cases less than about 100 nm; in some cases less than about 50 nm. In certain cases, silicate-based particles having an average particle size between about 10 nm and about 50 nm are preferred.

Preferably, the size of the silicate-based particles is generally uniform and the particle size distribution of the particles is small. In some cases, the quartile ratio (d₇₅/d₂₅) may be less than about 3 and, in some cases, less than about 2. The silicate-based particles preferably have a similar morphology which may be substantially spherical.

When in a dried state, the silicate-based particles of the invention can, in some cases, form clusters of particles or agglomerates. However, the clustered silicate-based particles are readily dispersible, for example, in an aqueous medium. Once dispersed the silicate-based particles are generally present as individual non-agglomerated particles.

The particulate characteristics of the silicate-based particles are generally beneficial when the silicate-based particles are mixed with barium titanate-based particles to produce dielectric compositions. The silicate-based particles of the invention can be uniformly dispersed in barium titanate-based particulate compositions and, particularly in compositions having sub-micron particle sizes and/or substantially spherical particle morphologies. The uniform distribution of the mixture may reduce the amount of the silicate-based sintering aid required to create uniform sintering throughout the dielectric body. Dielectric mixtures resulting from the mixture of such barium titanate-based particles and silicate-based particles may be suitable for producing ultra-thin dielectric layers (e.g., less than 3 microns after sintering).

When provided as coatings, the silicate-based layers generally have a thickness of between about 0.1 nm and about 10.0 nm and, in some cases, the thickness may be between about 0.5 nm and about 5.0 nm. The specific thickness depends, in part, upon the barium titanate-based particle size and the weight percentage of the silicate-based sintering aid added. In certain embodiments, it may be desirable to produce a coating over the entire particle surface. In some embodiments, the coating may have a uniform thickness such that the thickness of the coating varies by less than 20%. In other cases, the thickness may vary by larger amounts across the surface of an individual barium titanate-based particle. Particularly in cases where the coating layer thickness is low (i.e. less than 0.5 nm), the thickness of the coating may vary over different portions of the particles., In some cases, portions of the barium titanate-based particle surface may not be coated at all.

Particles of barium titanate-based material may be either coated with the silicate-based compound or mixed with the silicate-based particles of the invention to produce the dielectric composition. The barium titanate-based particles may comprise barium titanate, solid solutions thereof, or other oxides based on barium and titanate having the general structure ABO₃, where A represents one or more divalent metals such as barium, calcium, lead, strontium, magnesium and zinc and B represents one or more tetravalent metals such as titanium, tin, zirconium, and hafnium. An example of one type of barium titanate-based material has the structure Ba₍₁₋ₓ₎AₓT_{(1-y)}B_{y}O₃, where x and y can be in the range of 0 to 1, where A represents one or more divalent metals other than barium such as lead, calcium, strontium, magnesium and zinc and B represents one or more tetravalent metals other than titanium such as tin, zirconium and hafnium. Where the divalent or tetravalent metals are present as impurities, the value of x and y may be small, for example less than 0.1. In other cases, the divalent or tetravalent metals may be introduced at higher levels to provide a significantly identifiable compound such as barium-calcium titanate, barium-strontium titanate, barium titanate-zirconate, and the like. In still other cases, where x or y is 1.0, barium or titanium may be completely replaced by the alternative metal of appropriate valence to provide a compound such as lead titanate or barium zirconate. In other cases, the compound may have multiple partial substitutions of barium or titanium. An example of such a multiple partial substituted composition is represented by the structural formula Ba_{(1-x-x′-x″)}PbₓCa_{x′}S_{x″}O.Ti_{(1-y-y′-y″)}Sn_{y}Zr_{y′}Hf_{y″}O₂ where x, x′, x″, y, y′, and y″ are each greater than 0. In many cases, the barium titanate-based material will have a perovskite crystal structure, though in other cases it may not.

The barium titanate-based particles may have a variety of different particle characteristics. In preferred cases, the barium titanate-based particles have a small particle size. The barium titanate-based particles may have an average particle size of less than about 1.0 microns; in some cases, the average particle size is less than about 500 nanometer; in some cases, the average particle size may be less than about 150 nanometer; in some cases, the average particle size is less than about 100 nanometer.

The barium titanate-based particles may also have a variety of shapes which may depend, in part, upon the process used to produce the particles. In some cases, barium titanate-based particles having a substantially spherical morphology are preferred. In other cases, barium titanate-based particles may have an irregular, non-equiaxed shape which may result from a milling process.

The barium titanate-based particles may be produced according to any technique known in the art including hydrothermal processes, solid-state reaction processes, sol-gel processes, as well as precipitation and subsequent calcination processes, such as oxalate-based processes. In some embodiments, it may be preferable to produce the barium titanate-based particles using a hydrothermal process. Hydrothermal processes generally involve mixing a barium source with a titanium source in an aqueous environment to form a hydrothermal reaction mixture which is maintained at an elevated temperature to promote the formation of barium titanate particles. When forming barium titanate solid solution particles hydrothermally, sources including the appropriate divalent or tetravalent metal may also be added to the hydrothermal reaction mixture. Certain hydrothermal processes may be used to produce substantially spherical barium titanate-based particles having average particle sizes of 1.0 micron and smaller, and a uniform particle size distribution. Suitable hydrothermal processes for forming barium titanate-based particles have been described, for example, in commonly-owned U.S. Pat. Nos. 4,829,033, 4,832,939, and 4,863,883, which are incorporated herein by reference in their entireties.

In some embodiments, the barium titanate-based particles may have a coating including one or more dopant compound. Dopants are often metal compounds, such as oxides or hydroxides. The dopant compounds can enhance certain electrical and mechanical properties of the composition. Examples of suitable dopant compounds include lithium, magnesium, calcium, strontium, scandium, zirconium, hafnium, vanadium, niobium, tantalum, manganese, cobalt, nickel, zinc, boron, antimony, tin, yttrium, lanthanum, lead, bismuth or a Lanthanide element. In some embodiments, the dopant compounds are coated as chemically distinct coating layers. Suitable coated particles have been described, for example, in commonly-owned U.S. patent application Ser. No. 08/923,680, filed Sep. 4, 1997, which is incorporated herein by reference in its entirety. In these embodiments utilizing dopant-coated barium titanate-based particles, the silicate-based sintering aid may be provided as particles mixed with the coated barium titanate-based particles or as another chemically distinct coating layer produced using the above-described process. In other embodiments, the dopant compounds may also be provided as particles which may be mixed with the barium titanate-based particles.

The dielectric composition including barium titanate-based particles and silicate-based sintering aid, either in particulate or coating form, may be further processed as known in the art. In some embodiments, the A/B ratio may be adjusted prior to forming a dielectric layer. In some cases, the A/B ratio is adjusted to a value greater than 1. Barium titanate-based compositions having A/B ratios greater than 1 are desirable in certain MLCCs applications to improve compatibility of the composition with base metal electrodes. The A/B ratio may be adjusted according to any technique known in the art. In some embodiments, the A/B ratio may be increased by adding an insoluble barium compound, such as barium carbonate (BaCO₃), in particulate form to the composition. In other embodiments, the insoluble barium compound may be precipitated in particulate form to adjust the A/B ratio. In other embodiments, a barium compound, such as barium carbonate (BaCO₃), may be coated onto the surfaces of the barium titanate-based particles. The barium coating may be provided similarly, and in the same process, as the dopant coatings described above. In some embodiments, it may be preferable to deposit the barium coating on the particle surfaces as the first coating layer subsequent to depositing the dopant coating layers.

The dielectric composition may be further processed as known in the art to form to form dielectric layers. In one illustrative process to form the dielectric layer of an MLCC, the composition may be maintained as a slurry to which additives such as dispersants and binders may be added to form a castable slip. The slurry may be cast to provide a “green” layer of ceramic dielectric material. A patterned electrode material is then formed on the green layer to form a structure that is stacked to provide a laminate of alternating layers of green ceramic dielectric and electrode. In some embodiments, the preferred electrode material is nickel-based. The stacks are diced into MLCCs-sized cubes which are heated to burn off organic materials, such as binder and dispersant, and are then fired to sinter the particles of barium titanate-based material to form a capacitor structure with laminated, dense ceramic dielectric and electrode layers.

The silicate-based sintering aid lowers the temperature required to sinter the dielectric composition. For example, a typical dielectric composition including the sintering aid may be sintered at a temperature of less than between about 1250° C. and about 1350° C., as compared to the same dielectric composition without the sintering aid which requires sintering temperatures of greater than 1400° C. The silicate-based sintering aids of the invention also may be more effective at lowering the sintering temperature of dielectric compositions than conventional sintering aids. That is, a dielectric compositions including silicate-based sintering aids of the invention may be sintered at lower temperatures (e.g., by at least 25° C. lower) than the same dielectric composition that includes the same weight percentage of a conventional sintering aid. It is believed that the advantage in reducing sintering temperatures results from the uniform distribution of the silicate-based sintering aids of the present invention throughout the dielectric composition. This uniformity occurs both when the silicate-based sintering aids are produced as particles and when produced as coatings. The silicate-based particles have small particle sizes allowing them to be easily and uniformly dispersed throughout dielectric compositions. In certain cases when the silicate-based particles have a uniform particle sizes and a substantially spherical morphology, uniform dispersion may be enhanced. The silicate-based coatings are formed upon dielectric particles, thus, ensuring their uniform distribution throughout the composition.

The present invention will be further illustrated by the following examples, which are intended to be illustrative in nature and are not to be considered as limiting the scope of the invention.

### EXAMPLES

### Example 1

### Production and Characterization of Barium-Calcium Silicate Sintering Aid Particles

A barium-calcium silicate sintering aid was produced according to one method of the present invention. The resulting barium-calcium silicate particles were analyzed for particle characteristics and mixed with barium titanate-based particles to form a dielectric mixture that was further characterized. The barium-calcium silicate sintering aid was compared to a commercially available barium-calcium silicate sintering aid.

An aqueous solution of barium hydroxide octahydrate was mixed with an aqueous solution of calcium hydroxide in relative proportions to form an alkaline earth metal mixture having a Ba:Ca ratio of about 0.6:0.4. The alkaline earth metal mixture was heated to a temperature of about 85° C. and stirred vigorously, while an aqueous solution of sodium silicate was added to form a reaction mixture. The reaction mixture was continually stirred and maintained at a temperature of about 85° C. to ensure reaction completion. Barium-calcium silicate particles were produced having the composition Ba_{0.6}Ca_{0.4}SiO₃. The product was filtered, washed with de-ionized water to remove any excess reagents, and dried to produce barium-calcium silicate particles.

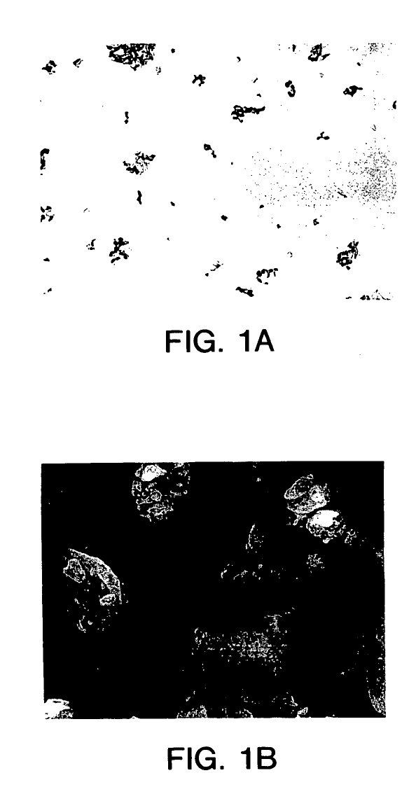

The dried barium-calcium silicate particles were analyzed for particle characteristics using transmission electron microscopy (TEM). The particles had a substantially spherical morphology, an average particle size of about 50 nm, and uniform particle sizes. Typical barium-calcium silicate particles appear in the TEM micrograph shown in FIG. 1A. The minor amounts of particle clustering that was present was determined to be an artifact of the drying process, as the particles were readily dispersible into individual primary particles.

A commercially available barium-calcium silicate particulate composition having the same composition (Ba_{0.6}Ca_{0.4}SiO₃) was also analyzed using TEM for comparative purposes. The commercial particles were produced by VIOX Corporation (Seattle, Wash.) using a conventional melt process that included a milling step. TEM analysis revealed that the commercially available particles had an irregular morphology indicative of being milled, a particle size between about 0.5 μm and about 10 μm, and non-uniform particle sizes. Typical commercially available barium-calcium silicate particles appear in the TEM micrograph shown in FIG. 1B. As compared to the particles produced according to the present invention (FIG. 1A), the commercial particles have significantly larger particle sizes, less spherical morphologies, and greater a particle size distribution.

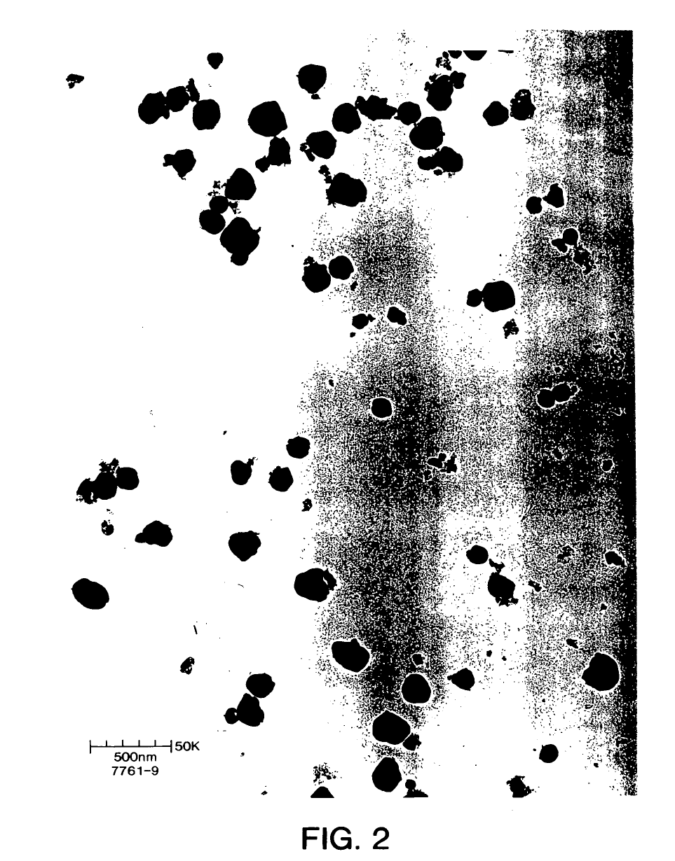

The barium-calcium silicate sintering aid particles were dispersed in hydrothermally-produced barium titanate-based particles (BaTiO₃) to form a dielectric composition having less than 5 weight percent of the sintering aid particles. The dielectric composition was analyzed using TEM. TEM analysis illustrated the size difference between the barium-calcium silicate particles (average particle size of about 50 nm) and barium titanate-based particles (average particle size of about 120 nm). TEM analysis also revealed that the barium-calcium silicate particles were present as individual particles when dispersed throughout the barium titanate-based particles. A typical TEM micrograph of the dielectric composition is shown in FIG. 2 in which the larger particles are barium titanate-based particles and the smaller particles are barium-calcium silicate particles.

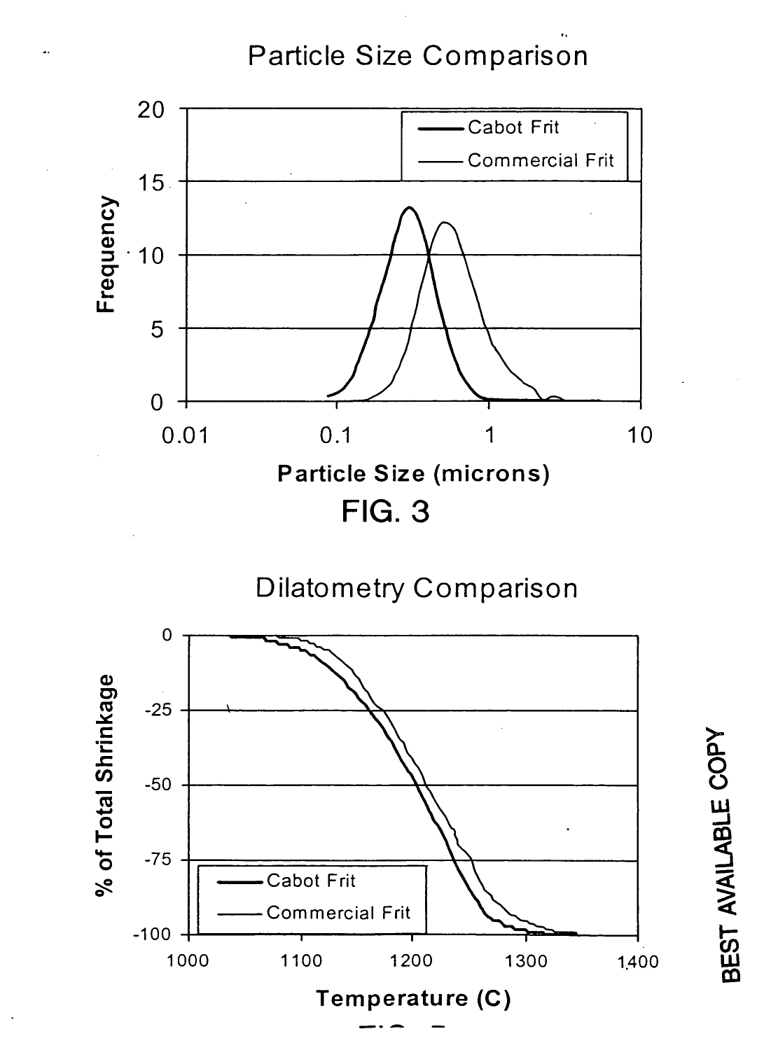

The particle size of the dielectric composition including the silicate-based particles of the invention and barium titanate-based particles was measured using a standard light-scattering technique. FIG. 3 shows the results obtained by the technique where line A represents the particle size of the dielectric composition including silicate-based particles of the invention. The graph shows that the average particle size of the dielectric composition is about 120 nanometers, which is approximately the average size of the barium titanate-based particles. The barium titanate-based particle size dominates the measurement because of the presence of many more barium titanate-based particles than the smaller silicate-based particles. Advantageously, the silicate-based particles did not increase the particle size of the composition.

A dielectric composition including the commercially available barium-calcium silicate particles described above and the same barium titanate-based particles (average particle size of about 120 nm) was produced for comparative purposes. The particle sizes of the dielectric compositions including the commercial particles was measured using the same light-scattering technique described above. FIG. 3 shows the results obtained by the technique wherein line B represents the particle size of the dielectric composition including the silicate-based particles of the invention. The graph shows that the average particle size of the dielectric composition is larger than the particle size of the barium titanate-based particles. Thus, the commercial particles have increased the overall particle size of the dielectric composition. As compared to the dielectric composition including silicate particles of the present invention, the dielectric composition including the commercial silicate particles has a considerably larger particle size.

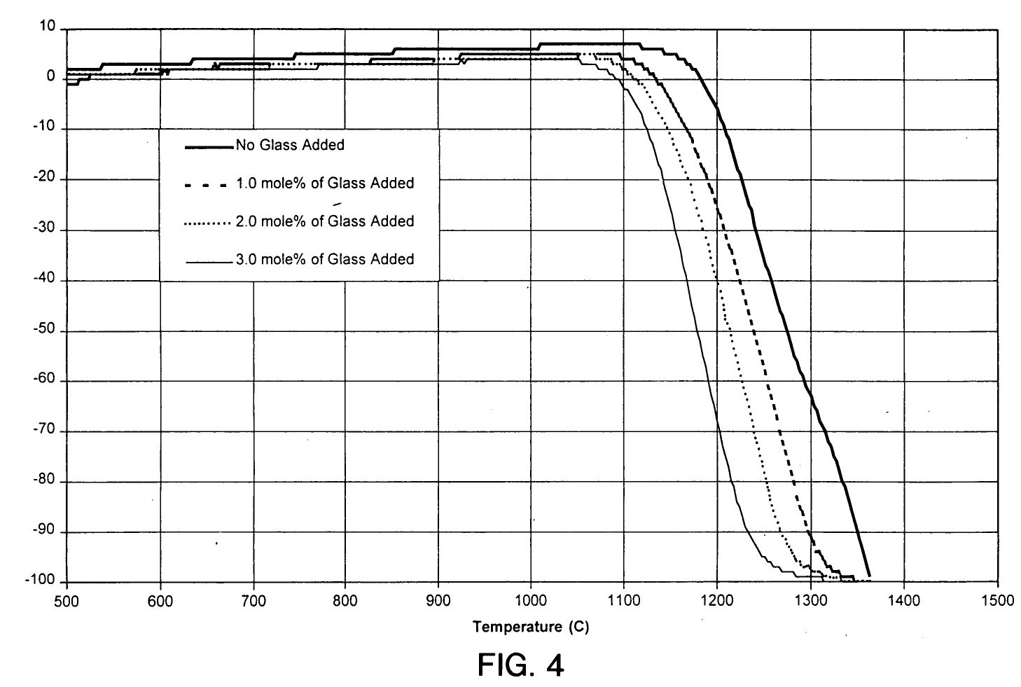

Dielectric compositions including various weight percentages (0 mol %, 1 mol %, 2 mol %, and 3 mol %) of the silicate-based particles of the invention were uniaxially pressed into pellets and analyzed using dilatometric thermal shrinkage techniques. The shrinkage profiles shown in FIG. 4 illustrate the reduction of the sintering temperature as silicate-based particle concentration increases. The sintering temperature was estimated as the temperature at which 80% of the shrinkage has occurred. Therefore, the sintering temperature of the dielectric composition has been reduced from greater than 1350° C., with 0 mol % silicate-based particles, to approximately 1225° C. by the introduction of the 3 mol % of the silicate-based particles. Electrical properties of the sintered pellets were also measured. The dielectric compositions exhibited a dielectric constant of 1500 and demonstrated a temperature stability of capacitance and dielectric loss which conformed to X7R specifications.

A dielectric composition including 2 mol % of the commercial silicate-based particles was uniaxially pressed into pellets and analyzed using dilatometric thermal shrinkage techniques for comparative purposes. FIG. 5 compares the shrinkage profile of the dielectric composition including the 2 mol % commercial silicate-based particles to the shrinkage profile of the dielectric composition including 2 mol % of the silicate-based particles of the invention. At the same weight percentage, the silicate-based particles of the invention have sintering temperatures about 25° C. lower than the dielectric composition including the commercial particles.

The example illustrates that barium-calcium silicate particles may be produced according to the process of the invention and that these particles may be dispersed in barium titanate-based particles to form a dielectric composition which may sintered to form a dielectric material. The particle characteristics of the barium-calcium silicate particles of the invention are superior to commercially available barium-calcium silicate particles. Furthermore, the properties of dielectric compositions including the barium-calcium silicate particles of the invention are superior to the properties of dielectric compositions including the commercially available barium-calcium silicate particles.

### Example 2

### Production and Characterization of Barium Silicate Sintering Aid Particles

A barium silicate sintering aid was produced according to one method of the present invention. The resulting barium silicate particles were mixed with barium titanate-based materials to form a dielectric mixture that was further characterized. The barium silicate sintering aid was compared to a commercially available silicon dioxide sintering aid.

An aqueous solution of barium hydroxide octahydrate was mixed with an aqueous solution of sodium silicate in relative proportions to form a reaction mixture having a Ba:Ca ratio of about 0.6:0.4. The reaction mixture was continually stirred and maintained at a temperature of about 85° C. to ensure reaction completion. Barium silicate particles were produced having the composition BaSiO₃. The product was filtered, washed with de-ionized water to remove any excess reagents, and dried to produce barium silicate particles.

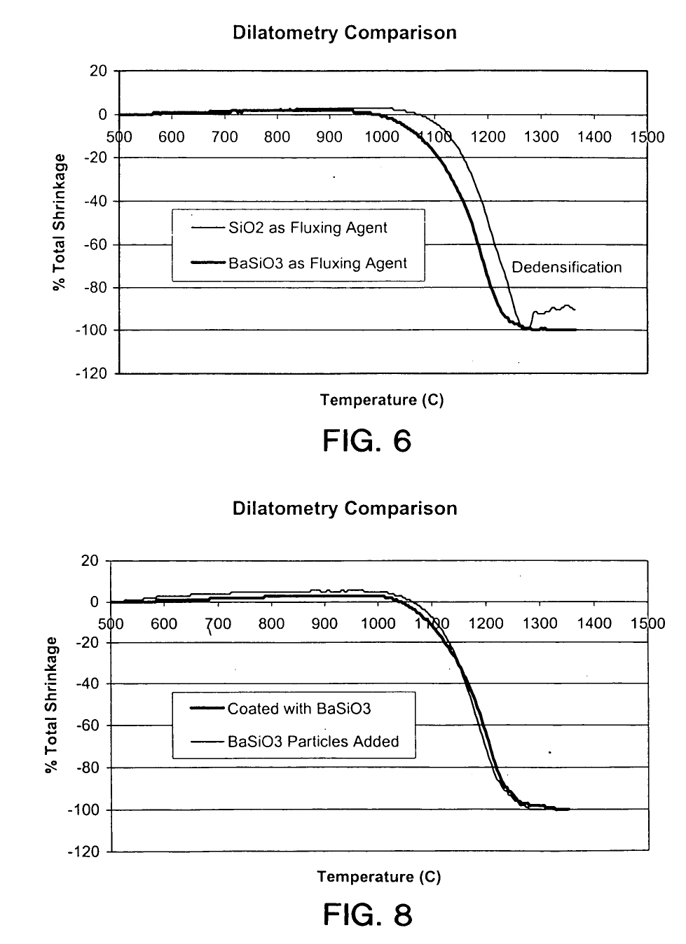

The barium silicate particles were added to a barium titanate-based particulate composition to form a dielectric composition. For comparative purposes, conventional silicon dioxide (SiO₂) particles were added to a barium titanate titanate-based composition to produce a dielectric composition. Both dielectric compositions had the same weight percentage of the sintering aid. Both dielectric compositions were analyzed using dilatometric thermal shrinkage techniques. The shrinkage profiles shown in FIG. 6 illustrate that barium silicate particles reduce the sintering temperature about 25° C. lower than the silicon dioxide particles.

This example illustrates that barium silicate particles may be produced according to the methods of the invention. The barium silicate particles may be used effectively as a sintering aid and can lower the sintering temperature more than a conventional SiO₂ sintering aid.

### Example 3

### Production of Silicate-Based Coatings on Barium Titanate-Based Particles and Characterization of the Coated Particles

Barium titanate-based particles were coated with a silicate-based coating according to one method of the present invention. The coated particles were further characterized and compared to a dielectric composition including silicate-based particles produced according to a method of the present invention.

Barium titanate (BaTiO₃) particles having a particle size of less than 500 nm were added to a barium hydroxide (Ba(OH)₂) solution. The solution was mixed to slurry the particles so that they were sufficiently suspended. An aqueous solution of sodium silicate (Na₂SiO₃) was added to the slurry while continuing mixing. The silicon ionic species (SiO₃²⁻) reacted with the barium ionic species (Ba²⁺) to form a barium silicate (BaSiO₃) coating on the surfaces of the barium titanate particles.

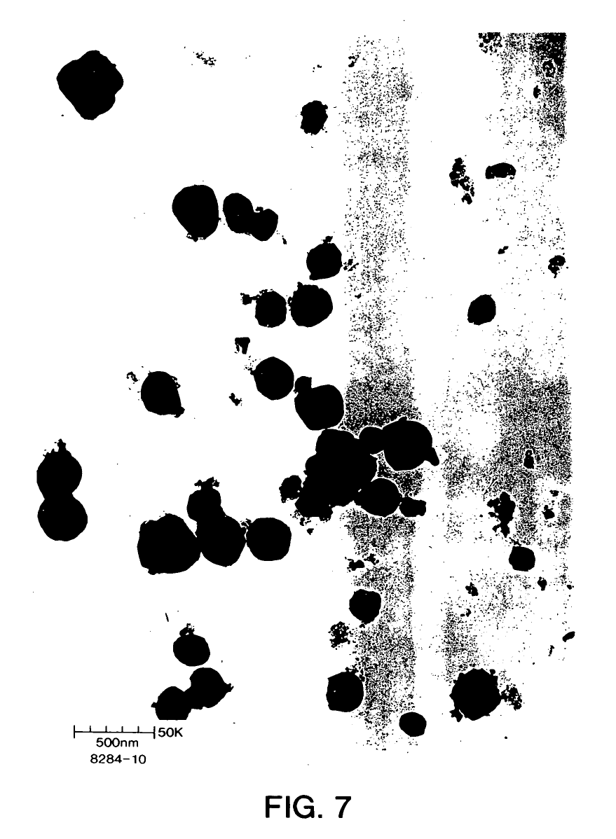

The coated particles were analyzed using TEM. The TEM analysis revealed that the barium titanate particles included a barium silicate coating on at least a part of their surfaces and that the coated particles had an average particle size of less than 500 nm. FIG. 7 is a typical TEM micrograph of the coated barium titanate particles.

The sintering characteristics of the coated barium titanate particles were compared to a dielectric composition including barium titanate particles and barium silicate particles produced according to a method of the invention using a dilatometric thermal shrinkage technique. The composition of the coated particles included the same weight percentage of barium silicate as the composition including the barium silicate particles. The shrinkage profiles illustrated in FIG. 8 shows that the two compositions have similar sintering behavior.

This examples illustrates that barium titanate-based particles may be coated with a silicate sintering aid composition according to a method of the present invention. The coated particle composition has similar advantageous sintering characteristics as compositions that include silicate particles produced according to methods of the present invention, which as illustrated in Examples 1 and 2, had superior sintering characteristics as comparted to conventional sintering aid particles.

It should be understood that although particular embodiments and examples of the invention have been described in detail for purposes of illustration, various changes and modifications may be made without departing from the scope and spirit of the invention. Accordingly, the invention is not to be limited except as by the appended claims.

What is claimed is:

1-32. (Canceled).

33. A barium titanate-based particulate composition comprising:
barium titanate-based particles coated with an alkaline earth metal silicate-based sintering aid.

34. The composition of claim 33, wherein the barium titanate-based particles have an average particle size of less than about 500 nm.

35. The composition of claim 33, wherein the barium titanate-based particles have an average particle size of less than about 150 nm.

36. The composition of claim 33, wherein the barium titanate-based particles are substantially spherical.

37. The composition of claim 33, wherein the alkaline earth metal is an alkaline earth metal from the group consisting of barium and calcium.

38. The composition of claim 33, wherein the alkaline earth metal silicate-based sintering aid has the formula BaₓCa₁₋ₓSiO₃, wherein 0<x<1.

39. The composition of claim 38, wherein x is between about 0.4 and about 0.6.

40. The composition of claim 33, wherein the coating includes a plurality of chemically distinct layers.

41. A barium titanate-based composition comprising a mixture of barium titanate-based particles and alkaline earth metal silicate-based particles having an average particle size of less than about 500 nm.

42. The barium titanate-based composition of claim 41, wherein the alkaline earth metal silicate-based particles have an average particle size of less than about 100 nm.

43. The barium titanate-based composition of claim 41, wherein the alkaline earth metal silicate-based particles have an average particle size of between about 10 nm and about 50 nm.

44. A multilayer ceramic capacitor comprising:
an electrode layer; and
a dielectric layer formed on the electrode layer, the dielectric layer comprising sintered barium titanate-based particles coated with an alkaline earth metal silicate-based sintering aid.

45. A multilayer ceramic capacitor comprising:
an electrode layer; and
a dielectric layer formed on the electrode layer, the dielectric layer comprising a mixture of sintered barium titanate-based particles and sintered alkaline earth metal silicate-based particles having an average particle size of less than about 500 nm.

46. The composition of claim 33, wherein the barium titanate-based particles are coated with at least one dopant compound.

47. The composition of claim 46, wherein the at least one dopant compound comprises a metal selected from the group consisting of lithium, magnesium, strontium, scandium, zirconium, hafnium, vanadium, niobium, tantalum, manganese, cobalt, nickel, zinc, boron, antimony, tin, yttrium, lanthanum, lead, bismuth and a Lanthanide element.

48. The composition of claim 33, wherein the barium titanate-based particles are coated with magnesium, manganese and yttrium.

49. The composition of claim 33, wherein the alkaline earth metal silicate-based sintering aid is barium silicate.

50. The composition of claim 33, wherein the barium titanate-based particles are coated with an alkaline earth metal silicate based coating layer and at least one layer that comprises a dopant metal.

51. The composition of claim 33, wherein the barium titanate-based particles are barium titanate particles.

52. The composition of claim 41, wherein the barium titanate-based particles are coated with at least one dopant metal compound.

53. The composition of claim 52, wherein the at least one dopant compound comprises a metal selected from the group consisting of lithium, magnesium, strontium, scandium, zirconium, hafnium, vanadium, niobium, tantalum, manganese, cobalt, nickel, zinc, boron, antimony, tin, yttrium, lanthanum, lead, bismuth and a Lanthanide element.

54. The composition of claim 52, wherein the barium titanate-based particles are coated with magnesium, manganese and yttrium.

55. The composition of claim 41, wherein the alkaline earth metal silicate-based particles are barium silicate particles.

56. The composition of claim 41, wherein the alkaline earth metal silicate-based particles are barium calcium silicate particles.

57. The composition of claim 41, wherein the barium titanate-based particles are barium titanate particles.
